(19) United States
(12) Patent Application Publication
(10) Pub. No.: US 2026/0028278 A1
(43) Pub. Date: Jan. 29, 2026

(54) PROCESS FOR PRODUCING A HOT BLENDED MATERIAL OF AMORPHOUS SILICON DIOXIDE – CRYSTALLINE SILICON DIOXIDE, PROCESS FOR PRODUCING ARTIFICIAL STONE FROM THE MATERIAL BY PRESS-VIBRATION METHOD IN VACUUM ENVIRONMENT AND THE ARTIFICIAL STONE PRODUCT OBTAINED FROM THIS PROCESS

(71) Applicant: A&A GREEN PHOENIX GROUP JOINT STOCK COMPANY, Hanoi City (VN)

(72) Inventors: Nang Xuan Ho, Hanoi City (VN); Dung Tri Pham, Hanoi City (VN); Thuc Quang Dong, Hanoi City (VN); Oanh Thi Bui, Hanoi City (VN); Son Anh Trung Hoang, Hanoi City (VN); Cuong Manh Tran, Hanoi City (VN)

(21) Appl. No.: 19/117,213

(22) PCT Filed: Apr. 24, 2024
(86) PCT No.: PCT/IB2024/054013

§ 371 Date: Mar. 31, 2025

(30) Foreign Application Priority Data
Jul. 11, 2023 (VN) 1-2023-04552
Jan. 12, 2024 (VN) 1-2024-00249

(51) Int. Cl. C04B 14/22; C03C 1/00; C03C 3/06; C03C 3/087; C03C 10/00; C04B 20/04; C04B 26/02; C04B 111/54

(52) U.S. Cl. CPC C04B 14/22; C03C 1/002; C03C 3/06; C03C 3/087; C03C 10/0009; C04B 20/04; C04B 26/02; C04B 2111/54; C04B 2201/52

(57) ABSTRACT

The present invention relates to process for producing a hot blended material of amorphous silicon dioxide—crystalline silicon dioxide (Hot Blending silica—PheniSilic™) from materials containing silicon dioxide such as sand, cristobalite, crushed glass, waste rock powder/burrs from process of producing artificial stone, waste products and by-products from the exploitation and processing of natural quartz stone. The present invention also relates to artificial stone product produced by using base resins such as unsaturated polyester, epoxy, acrylic or combination thereof and reinforcement is the hot blended material of amorphous silicon dioxide—crystalline silicon dioxide wherein the artificial stone has a flexural strength≥40N/mm², a water absorption≤0.05%, an impact resistance≥3J, as well as process for producing this artificial stone.

### FIELD OF THE INVENTION

The present invention relates to process for producing a hot blended material of amorphous silicon dioxide—crystalline silicon dioxide (Hot Blending silica—PheniSilic™) from materials containing silicon dioxide such as sand, cristobalite, crushed glass, waste rock powder/burrs from process of producing artificial stone, waste products and by-products from the exploitation and processing of natural quartz stone. The present invention also relates to artificial stone product produced by using base resins such as unsaturated polyester, epoxy, acrylic or combination thereof and reinforcement is the hot blended material of amorphous silicon dioxide—crystalline silicon dioxide wherein the artificial stone has a flexural strength≥40 N/mm², a water absorption≤0.05%, an impact resistance≥3J, as well as process for producing this artificial stone.

### BACKGROUND OF THE INVENTION

In some recent studies, the use of materials such as quartz/silica sand, in general, during industrial production, generates silicon dioxide dust in crystalline form. This dust, when released into the air, can have a harmful effect on human health through the respiratory tract, causing a lung disease called silicosis. Therefore, there is a need for a material that has properties equivalent to quartz/silica sand but does not generate silica dust in in crystalline form or has limited controlled emission levels during industrial production.

Amorphous silica is a form of silica material with an amorphous structure, unlike quartz/silica sand in crystalline form. Therefore, during industrial production, no crystalline silica dust is emitted. However, in the production of artificial stone, amorphous silicon material is used only as a secondary type due to it has the SiO₂ ratio in range of 50 to 70% by weight (regular glass), which does not ensure the properties of artificial stone products, they are not commonly and widely used.

### SUMMARY OF THE INVENTION

The object of the present invention is to provide a process for producing a hot blended material of amorphous silicon dioxide-crystalline silicon dioxide (Hot Blending silica—PheniSilic™) from materials containing silicon dioxide such as sand, cristobalite, crushed glass, waste rock powder/burrs from process of producing artificial stone, waste products and by-products from the exploitation and processing of natural quartz stone, after that the material is used as reinforcement for producing artificial stone product by press-vibration method in a vacuum environment.

To obtain the above-mentioned object, according to one aspect, the present invention provides a process for producing a hot blended material of amorphous silicon dioxide—crystalline silicon dioxide (Hot Blending silica—PheniSilic™) from materials containing silicon dioxide such as sand, cristobalite, crushed glass, waste rock powder/burrs from process of producing artificial stone, waste products and by-products from the exploitation and processing of natural quartz stone, etc., the process includes the following steps:
i) heating a mixture of sand, crushed glass and solid waste from quartz stone production in amount of from 60 to 90% by weight together with additional materials which are soda/feldspar (Na₂O) in amount of from 1 to 10% by weight, aluminum oxide/feldspar powder (Al₂O₃) in amount of from 1 to 10% by weight; limestone/dolomite (CaCO₃/MgCO₃) in amount of from 5 to 10% by weight and processing aid at a temperature between 1000° C. and 1600° C. to obtain molten amorphous silicon dioxide component (component A) with amorphous silicon dioxide content in range of from 50 to 90% by weight;
ii) preparing crystalline silicon dioxide (component B) by mixing of calcined impurities-removed sand (component B1) with crystalline silicon dioxide in form of cristobalite (component B2), wherein crystalline silicon dioxide (component B) is prepared as followings:
calcining sand at temperature in range of 1000 to 1600° C. for removing impurities to obtain calcined impurities-removed sand (component B1);
calcining obtained sand with additives such us alkali salts or alkali hydroxides at temperature in range of 1000 to 1600° C. to obtain crystalline silicon dioxide in form of cristobalite (component B2);
iii) mixing the molten amorphous silicon dioxide (component A) with crystalline silicon dioxide (component B) wherein the proportion of the component A is in range from 50 to 99% by weight and the proportion of component B is in range of 1 to 50% by weight, wherein the total silicon dioxide content of the obtaining product ranges from about 70% to 95% by weight;
iv) cooling the mixture of component A and component B quickly to form a large-particle mass; and
v) grinding the large-particle mass from step (iv) by a mill system to obtain the hot blended material of amorphous silicon dioxide—crystalline silicon dioxide (Hot Blending silica—PheniSilic™) with the desired sizes.

In one embodiment of the invention, at the step (i), the heating to form molten glass is performed at 1300° C. for 2 hours.

In one embodiment of the invention, at the step (ii), the calcining to obtain calcined impurities-removed sand is performed at 1300° C. for 2 hours and the calcining to obtain crystalline silicon dioxide in form of cristobalite is performed at 1500° C. for 2 hours.

In one aspect, the present invention relates to a hot blended material of amorphous silicon dioxide—crystalline silicon dioxide (Hot blending Silica—PheniSilic™) obtained from the process of the invention, wherein the material is consisting of chemical compositions as following:
70%<SiO₂<95% by weight, wherein the amorphous SiO₂ is in range from 50 to 90% by weight; crystalline SiO₂ is in range from 1 to 50% by weight;
1,0%<Na₂O<10% by weight;
1,5%<CaO/MgO<10% by weight;
1,0%<Al₂O₃<10% by weight;
and other additives such as Fe₂O₃<0,1% by weight, TiO₂<0,1% by weight.

The blended material of amorphous silicon dioxide—crystalline silicon dioxide of the invention (Hot blending Silica—PheniSilic™) has properties equivalent to quartz/silica sand and especially with the advantage of not generating silica dust in the crystalline form or controlled emission during the production and processing of an artificial stone product, thereby reducing harmful effects on human health through the respiratory tract due to the use of materials such as quartz/silica sand.

In one aspect, the present invention provides a process for producing artificial stone, wherein the process includes the following steps:
i) heating a mixture of sand, crushed glass and solid waste from quartz stone production in amount of from 60 to 90% by weight together with additional materials which are soda/feldspar (Na₂O) in amount of from 1 to 10% by weight, aluminum oxide/feldspar powder (Al₂O₃) in amount of from 1 to 10% by weight; limestone/dolomite (CaCO₃/MgCO₃) in amount of from 5 to 10% by weight and processing aid at a temperature between 1000° C. and 1600° C. to obtain molten amorphous silicon dioxide component (component A) with amorphous silicon dioxide content in range of from 50 to 90% by weight;
ii) preparing crystalline silicon dioxide (component B) by mixing of calcined impurities-removed sand (component B1) with crystalline silicon dioxide in form of cristobalite (component B2), wherein crystalline silicon dioxide (component B) is prepared as followings:
calcining sand at temperature in range of 1000 to 1600° C. for removing impurities to obtain calcined impurities-removed sand (component B1);
calcining obtained sand with additives such us alkali salts or alkali hydroxides at temperature in range of 1000 to 1600° C. to obtain crystalline silicon dioxide in form of cristobalite (component B2);
iii) mixing the molten amorphous silicon dioxide (component A) with crystalline silicon dioxide (component B) wherein the proportion of the component A is in range from 50 to 99% by weight and the proportion of component B is in range of 1 to 50% by weight, wherein the total silicon dioxide content of the obtaining product ranges from about 70% to 95% by weight;
iv) cooling the mixture of component A and component B quickly to form a large-particle mass; and
v) grinding the large-particle mass from step (iv) by a mill system to obtain the hot blended material of amorphous silicon dioxide—crystalline silicon dioxide (Hot Blending silica—PheniSilic™) with the desired sizes;
(vi) producing artificial stone products by using blended material of amorphous silicon dioxide—crystalline silicon dioxide obtained in the step (v) and base resins such as unsaturated polyester, epoxy, acrylic or combination thereof by press-vibration method in a vacuum environment, in which the ratio of base resin used is in range from 6 to 15% by weight and the ratio of blended material of amorphous silicon dioxide—crystalline silicon dioxide obtained in the step (v) is in range from 85 to 94% by weight.

In one aspect, the present invention provides a artificial stone product obtained from the process of the invention, wherein the artificial stone product comprises base resins such as unsaturated polyester, epoxy, acrylic with the ratio in range from 6 to 15% by weight and reinforcement is the hot blended material of amorphous silicon dioxide—crystalline silicon dioxide (Hot blending Silica—PheniSilic™) with the ratio in range from 85 to 94% by weight, wherein the total ratio of silicon dioxide is range from 70% to 95% by weight and the artificial stone product has a flexural strength≥40 N/mm², a water absorption≤0.05%, an impact resistance≥3J.

### BRIEF DESCRIPTION OF DRAWINGS

FIG. 1 is a diagram of the equipment for the heating process and creating a hot blended material of amorphous silicon dioxide—crystalline silicon dioxide (Hot blending Silica-PheniSilic™) according to an embodiment of the invention.

FIG. 2 is the morphology of the resulting hot blended material of amorphous silicon dioxide—crystalline silicon dioxide (Hot blending Silica—PheniSilic™).

FIG. 3 is an artificial stone product using the material of hot blended material of amorphous silicon dioxide—crystalline silicon dioxide (Hot blending Silica—PheniSilic™) or mixture of materials of Hot blending Silica—PheniSilic™ and quartz, sand, cristobalite.

FIG. 4 is an image of the sample of the hot blended material of amorphous silicon dioxide—crystalline silicon dioxide (Hot Blending silica—PheniSilic™) before and after grinding grinding into granular strips under a microscope.

FIG. 5 shows the X-ray diffraction (XRD) and infrared spectroscopy (FTIR) of the sample of the hot blended material of amorphous silicon dioxide—crystalline silicon dioxide (Hot Blending silica—PheniSilic™).

### DETAILED DESCRIPTION

Hereinafter, the preferred embodiments of the process according to the invention shall be described in more detail. However, note that the scope of the invention is not limited to the preferred embodiments described below as illustrative examples of the invention, and it should be understood that the scope of the invention includes all their modifications and other equivalent changes.

### Blending Components

### Sand

The sand used according to the invention is white sand that has an iron oxide content below the allowable level for the sand for use in glass production, and does not require enrichment, has moisture content below 4.5%, and no clotted phenomenon.

### Crushed Glass

The crushed glass used according to the present invention is glass beads of various sizes such as 0.3÷0.6 mm, 1.2÷2.5 mm, 3.0÷5.0 mm, etc., purchased from suppliers of glass beads from recycled sources.

Solid Waste from Quartz Stone Production

Waste rock powder/burrs from production of artificial stone have particle size in range of 0.1 to 10 nm, waste products and by-products from the exploitation and processing of natural quartz stone.

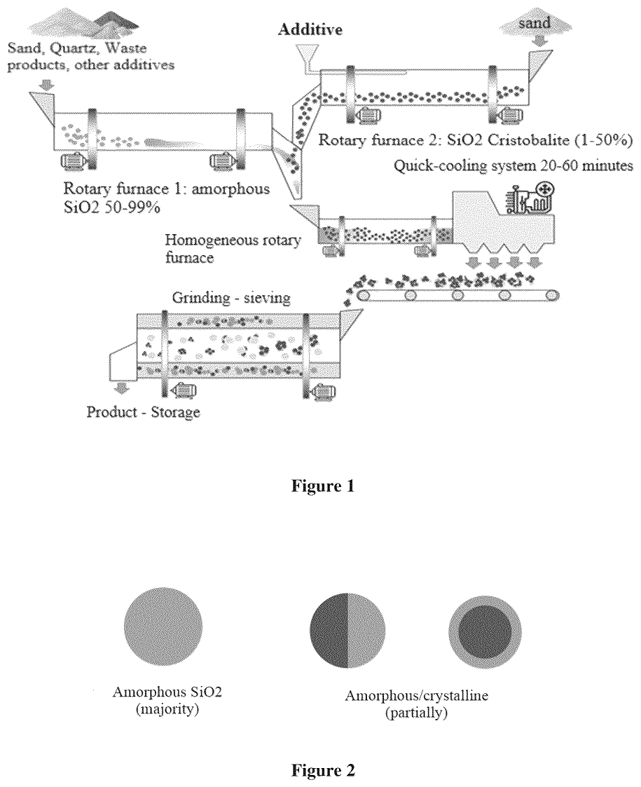

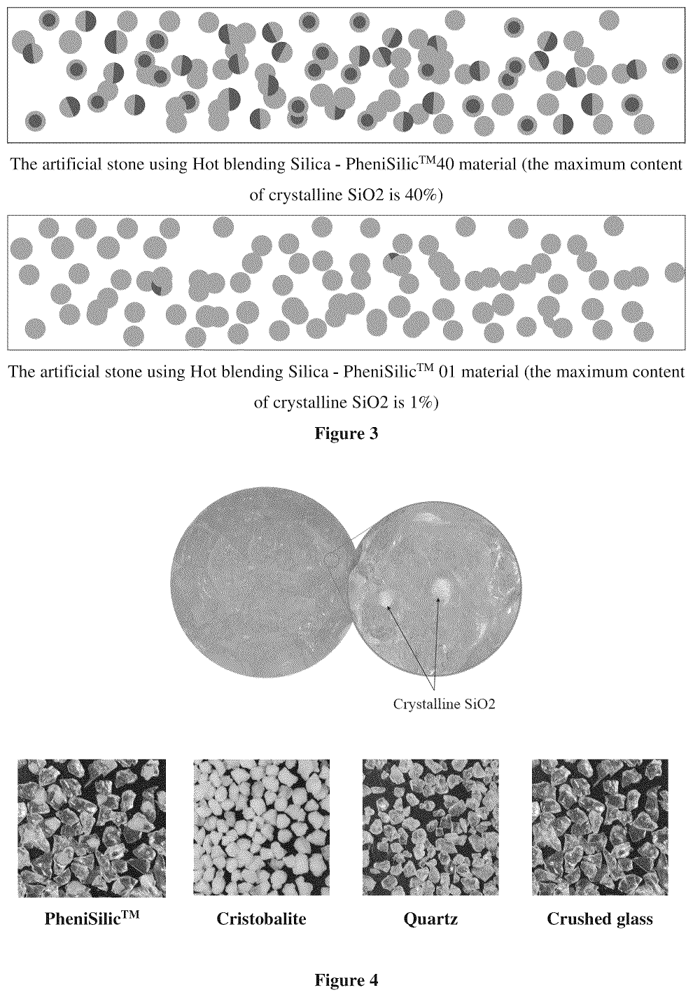

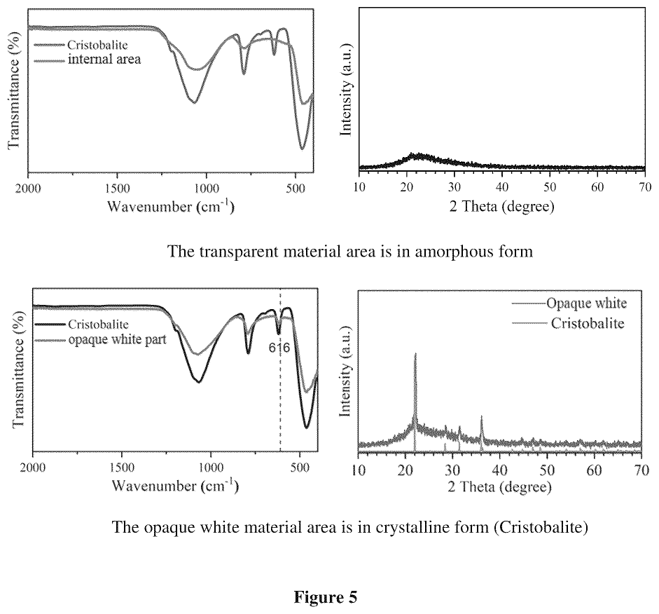

In the first aspect, as shown in FIG. 1, the present invention provides a process for producing a hot blended material of amorphous silicon dioxide—crystalline silicon dioxide (Hot Blending silica—PheniSilic™) from materials containing silicon dioxide such as sand, cristobalite, crushed glass, waste rock powder/burrs from process of producing artificial stone, waste products and by-products from the exploitation and processing of natural quartz stone, the process includes the following steps:
i) heating a mixture of sand, crushed glass and solid waste from quartz stone production in amount of from 60 to 90% by weight together with additional materials which are soda/feldspar (Na₂O) in amount of from 1 to 10% by weight, aluminum oxide/feldspar powder (Al₂O₃) in amount of from 1 to 10% by weight; limestone/dolomite (CaCO₃/MgCO₃) in amount of from 5 to 10% by weight and processing aid at a temperature between 1000° C. and 1600° C. to obtain molten amorphous silicon dioxide component (component A) with amorphous silicon dioxide content in range of from 50 to 90% by weight;
ii) preparing crystalline silicon dioxide (component B) by mixing of calcined impurities-removed sand (component B1) with crystalline silicon dioxide in form of cristobalite (component B2), wherein crystalline silicon dioxide (component B) is prepared as followings:
calcining sand at temperature in range of 1000 to 1600° C. for removing impurities to obtain calcined impurities-removed sand (component B1);
calcining obtained sand with additives such us alkali salts or alkali hydroxides at temperature in range of 1000 to 1600° C. to obtain crystalline silicon dioxide in form of cristobalite (component B2);
iii) mixing the molten amorphous silicon dioxide (component A) with crystalline silicon dioxide (component B) wherein the proportion of the component A is in range from 50 to 99% by weight and the proportion of component B is in range of 1 to 50% by weight, wherein the total silicon dioxide content of the obtaining product ranges from about 70% to 95% by weight;
iv) cooling the mixture of component A and component B quickly to form a large-particle mass; and
v) grinding the large-particle mass from step (iv) by a mill system to obtain the hot blended material of amorphous silicon dioxide—crystalline silicon dioxide (Hot Blending silica—PheniSilic™) with the desired sizes.

In some embodiments, the step (i) is performed by thoroughly mixing the main ingredient and additional ingredients including one or more types of main ingredients in amount of from 60 to 90% by weight such as natural sand, cristobalite, glass/crushed glass, waste rock powder/burrs from process of producing artificial stone, waste products and by-products from the exploitation and processing of natural quartz stone and with or without additives, wherein the content of soda/feldspar (Na₂CO₃) in amount of from 1 to 10% by weight, aluminum oxide/feldspar powder (Al₂O₃) in amount of from 1 to 10% by weight; limestone/dolomite (CaCO₃/MgCO₃) in amount of from 5 to 10% by weight and the additives in range of from 0 to 10% by weight, preferably in range of from 0 to 1% by weight in order to prepare the mixture.

Here, the molten mixture is heated to a temperature in range of 1000 to 1600° C. in following stages:
stage 1 (heating phase): gradually increase the temperature from room temperature to melting temperature in 2 hours (heating rate˜10÷20° C./min) to create a molten mixture; stage 2 (maintaining phase): maintain at firing temperature for 1 to 3 hours.

In some preferred embodiments, in this step, some additives can be used to adjust processing aids, for example to increase physical and mechanical durability such as SiO₂, Al₂O₃, ZrO₂; reduce the firing temperature such as K₂O, Na₂O, CaO, MgO, and increase chemical durability such as CaO, MgO, or color additives from metals or metal oxides such as manganese, selenium, tin oxide.

In one preferred embodiment, in the step (i), the heating to form molten glass is performed at the temperature 1300° C. for 2 hours.

In some embodiments, in step (ii), preparing crystalline silicon dioxide (component B) from calcined impurities-removed sand (component B1) with crystalline silicon dioxide in form of cristobalite (component B2), wherein calcined impurities-removed sand (component B1) is prepared by heating sand in rotary furnace 2 for removing impurities at the temperature in range of 1000 to 1600° C., the heating process includes stages as followings:
stage 1 (heating phase): gradually increase the temperature from room temperature to melting temperature in 2 hours (heating rate˜10÷20° C./min) to create a molten mixture;
stage 2 (maintaining phase): maintain at firing temperature for 1 to 3 hours.

In some embodiments, crystalline silicon dioxide in form of cristobalite (component B2) is prepared from calcined sand and additives such us alkali salts or alkali hydroxides at temperature in range of 1000 to 1600° C., the heating process includes two stages as followings:
stage 1 (heating phase): gradually increase the temperature from room temperature to melting temperature in 2 hours (heating rate˜10÷20° C./min) to create a molten mixture;
stage 2 (maintaining phase): maintain at firing temperature for 1 to 3 hours.

In one embodiment of the invention, at the step (ii), the calcining to obtain calcined impurities-removed sand is performed at 1300° C. for 2 hours and the calcining to obtain crystalline silicon dioxide in form of cristobalite is performed at 1500° C. for 2 hours.

In some preferred embodiments, step iii) is performed by mixing the molten amorphous silicon dioxide (component A) with crystalline silicon dioxide (component B) wherein the proportion of the component A is in range from 50 to 99% by weight and the proportion of component B is in range of 1 to 50% by weight, wherein the total silicon dioxide content of the obtaining product ranges from about 70% to 95% by weight.

In one aspect, the present invention relates to a hot blended material of amorphous silicon dioxide—crystalline silicon dioxide (Hot blending Silica—PheniSilic™) obtained from the process of the invention, wherein the material is consisting of chemical compositions as following:
70%<SiO₂<95% by weight, wherein the amorphous SiO₂ is in range from 50 to 90% by weight; crystalline SiO₂ is in range from 1 to 50% by weight;
1,0%<Na₂O<10% by weight;
1,5%<CaO/MgO<10% by weight;
1,0%<Al₂O₃<10% by weight;
and other additives such as Fe₂O₃<0,1% by weight, TiO₂<0,1% by weight.

The hot blended material of amorphous silicon dioxide—crystalline silicon dioxide (Hot blending Silica—PheniSilic™) is obtained in solid state. Unlike natural quartz stone, which has a crystalline SiO₂ content>99% by weight, the material of Hot blending Silica—PheniSilic™ which has a total silicon dioxide content in ranges from about 70% to 95% by weight wherein the main ingredient is amorphous silicon dioxide in range from 50 to 99% by weight and crystalline silicon dioxide in range of 1 to 50% by weight and a very small portion of other impurities are metal oxides from additives added during the synthesis process such as iron oxide, aluminum oxide, titanium oxide, etc. In addition, in step (iii), the mixing of molten amorphous silicon dioxide (component A) with crystalline silicon dioxide (component B) in order to cover the crystalline silicon dioxide component by amorphous silicon dioxide to reduce the ability to disperse crystalline silicon dioxide during the production and processing of current quartz-based artificial stone products with a silicon dioxide content of >90% by weight which affects the formation and development of silicosis. The homogeneous mixing of molten glass (component A—molten amorphous silicon dioxide) and calcined sand or critobalite (component B—crystalline silicon dioxide) is carried in a homogeneous rotary furnace, in which molten glass (component A) and calcined sand or critobalite (component B) are injected from rotary furnaces 1 and 2 into a homogeneous rotary furnace 3 with weight ratios of component A/component B=(50÷99% by weight)/(1÷50% by weight), helping to create a blending material of amorphous silicon dioxide and crystalline silicon dioxide in desired ratio with total content of silicon dioxide in range of 70% to 95% by weight.

In some embodiment of the invention, in the step iv), the quick cooling of mixture of component A and component B to form large-particle mass is carried out down to 90÷110° C. in short time of 30 to 60 mins. Then, the mixture is naturally cooled to room temperature.

In some embodiments of the invention, in the step (v), grinding the particle mass formed in step (iv), to obtain hot blended material of amorphous silicon dioxide—crystalline silicon dioxide (Hot blending Silica—PheniSilic™) with desired sizes, is carried out as following: particle mass with large sizes is formed from step (iv) after being cooled to room temperature, then put into the grinding equipment to grind into particles with desired size, for example, particle size of 0.1-0.4 mm; particle size of 0.3-0.6 mm, etc.

The material particles obtained after grinding are composed of the particles of amorphous silicon dioxide and the particles of crystalline silicon dioxide that is completely or partially enveloped by amorphous silicon dioxide in which the proportion of the component A is in range from 50 to 99% by weight and the proportion of component B is in range of 1 to 50% by weight according to the initially mixed ratio.

In one aspect, the present invention provides a process for producing artificial stone, wherein the process includes the following steps:
i) heating a mixture of sand, crushed glass and solid waste from quartz stone production in amount of from 60 to 90% by weight together with additional materials which are soda/feldspar (Na₂O) in amount of from 1 to 10% by weight, aluminum oxide/feldspar powder (Al₂O₃) in amount of from 1 to 10% by weight; limestone/dolomite (CaCO₃/MgCO₃) in amount of from 5 to 10% by weight and processing aid at a temperature between 1000° C. and 1600° C. to obtain molten amorphous silicon dioxide component (component A) with amorphous silicon dioxide content in range of from 50 to 90% by weight;
ii) preparing crystalline silicon dioxide (component B) by mixing of calcined impurities-removed sand (component B1) with crystalline silicon dioxide in form of cristobalite (component B2), wherein crystalline silicon dioxide (component B) is prepared as followings:
calcining sand at temperature in range of 1000 to 1600° C. for removing impurities to obtain calcined impurities-removed sand (component B1);
calcining obtained sand with additives such us alkali salts or alkali hydroxides at temperature in range of 1000 to 1600° C. to obtain crystalline silicon dioxide in form of cristobalite (component B2);
iii) mixing the molten amorphous silicon dioxide (component A) with crystalline silicon dioxide (component B) wherein the proportion of the component A is in range from 50 to 99% by weight and the proportion of component B is in range of 1 to 50% by weight, wherein the total silicon dioxide content of the obtaining product ranges from about 70% to 95% by weight;
iv) cooling the mixture of component A and component B quickly to form a large-particle mass; and
v) grinding the large-particle mass from step (iv) by a mill system to obtain the hot blended material of amorphous silicon dioxide—crystalline silicon dioxide (Hot Blending silica-PheniSilic™) with the desired sizes;
(vi) producing artificial stone products by using blended material of amorphous silicon dioxide—crystalline silicon dioxide obtained in the step (v) and base resins such as unsaturated polyester, epoxy, acrylic or combination thereof by press-vibration method in a vacuum environment, in which the ratio of base resin used is in range from 6 to 15% by weight and the ratio of blended material of amorphous silicon dioxide—crystalline silicon dioxide obtained in the step (v) is in range from 85 to 94% by weight.

In one aspect, the present invention provides a artificial stone product obtained from the process of the invention, wherein the artificial stone product comprises base resins such as unsaturated polyester, epoxy, acrylic with the ratio in range from 6 to 15% by weight and reinforcement is the hot blended material of amorphous silicon dioxide—crystalline silicon dioxide (Hot blending Silica—PheniSilic™) with the ratio in range from 85 to 94% by weight, wherein the total ratio of silicon dioxide is range from 70% to 95% by weight and the artificial stone product has a flexural strength≥40 N/mm², a water absorption≤0.05%, an impact resistance≥3J.

In some embodiments of the invention, step vi) for producing the artificial stone product using the base phase of synthesis resins and reinforcement of the material of Hot blending Silica-PheniSilic™or mixture of the material of Hot blending Silica—PheniSilic™ with quartz, cristobalite, sand, etc., by press-vibration method in a vacuum environment.

In some embodiments of the invention, in step (vi), the artificial stone product using the base phase of synthesis resins with the ratio in range from 6 to 15% by weight and reinforcement of the material of Hot blending Silica—PheniSilic™ or mixture of the material of Hot blending Silica—PheniSilic™ with sand, quartz, cristobalite, etc., with the ratio in range from 85 to 94% by weight.

In some embodiments, in step (vi), the binder used to form the sheet is selected from a group consisting of epoxy resins, unsaturated polyester resins, etc, or any suitable combination thereof. However, the invention is not limited to those resins. The binder resin to form the sheet can be colorlessly transparent or can be colored as required by adding inorganic pigments. The binder resin to form the sheet can be of the type that uses for indoor applications or of the type that is ultraviolet (UV) resistant for use in outdoor applications.

In some embodiments, the material mixture is press-vibrated in a mold under vacuum pressure conditions of 10 to 25 mbar (1000 to 2500 Pa) to effectively remove the amount of air present in the resin block to form a solid stone sheet maximumly:

To achieve this effect, it is preferable that the press-vibrating process under vacuum conditions is carried out in two or more stages, each lasting from 1 to 10 minutes with a vibration frequency ranging from 500 to 3000 rpm.

In some embodiments, after the press-vibration under vacuum conditions, the mixture in the mold is solidified under cold solidification or hot solidification conditions depending on the type of binder resin used. The solidification ends when the binder resin is cured and completely dry.

In some embodiments of the invention, the artificial stone product using reinforcement of the material of Hot blending Silica—PheniSilic™ which has properties as shown in Table 1:

TABLE 1

| Physical and mechanical properties | Test method | Value |
|---|---|---|
| Water absorption, % | BS EN 14617-1: 2013 | ≤0.05 |
| Flexural strength, N/mm² | BS EN 14617-2: 2016 | ≥40.0 |
| Impact resistance, J | BS EN 14617-9: 2005 | ≥3.0 |
| Scratch hardness of surface, Mohs | EN 101: 1991 | ≤8.0 |

The blended material of amorphous silicon dioxide—crystalline silicon dioxide of the invention (Hot blending Silica—PheniSilic™) has properties equivalent to quartz/silica sand and especially with the advantage of not generating silica dust in the crystalline form or controlled emission during the production and processing of an artificial stone products, thereby reducing harmful effects on human health through the respiratory tract due to the use of materials such as quartz/silica sand.

### EXAMPLES

The invention is illustrated by the following examples, but these examples should not be construed to limit the scope of the invention in any way.

### Example 1: Process for Producing a Hot Blended Material of Amorphous Silicon Dioxide-Crystalline Silicon Dioxide (Hot Blending Silica—PheniSilic™) from Materials Containing Silicon Dioxide Such as Sand, Cristobalite, Crushed Glass, Waste Rock Powder/Burrs from Process of Producing Artificial Stone, Waste Products and by-Products from the Exploitation and Processing of Natural Quartz Stone

### Preparing Molten Glass (Component A—Moltent Amorphous Silicon Dioxide)

500 kg of natural sand in a dry state with an average particle size of 0.5 mm, 500 kg of crushed glass from the broken glass which is a waste product of the glass factory crushed into a size of <10 mm, 600 kg of by-products from the artificial stone production and 260 kg of Na₂CO₃>99% by weight, 90 kg of aluminum oxide powder, 120 kg of limestone are mixed together to obtain a mixture.

This mixture is put into the furnace and heated from ambient temperature to 1300° C. for 2 hours (heating rate˜12,3° C./min), maintaining time is 2 hours, the resulting product is molten glass (component A).

Add tin oxide with antimony and zinc oxide to create opaque white molten amorphous silicon dioxide.

### Preparing Crystalline Silicon Dioxide (Component B)

450 kg of sand is heated in the rotary furnace 2. The heating process is performed from ambient temperature to 1300° C. for 2 hours (heating rate˜10.6° C./min), maintaining time is 2 hours, the resulting product is calcined impurities-removed sand (component B1).

A mixture of 445 kg of sand and 5 kg of Na₂CO₃ (ensuring the additive ratio is 1% by weight) is put into rotary furnace 2. The heating process is performed from ambient temperature to 1500° C. for 2 hours (heating rate˜12.3° C./min), maintaining time is 2 hours, the resulting product is cristobalite (component B2).

The products obtaining from above steps, which are the component A, and the mixture of component B1 and component B2, are added into a homogeneous rotary furnace, then mixed for 30 mins, then poured the mixture into the tank for rapid cooling to a temperature ranging from 90° C. to 110° C. for 45 mins and then cooled to ambient temperature for 1 hour.

After cooling, the large-particle mass is fed into the grinding system and grinded into desired particle sizes as shown in the Table 2:

TABLE 2

| Particle sizes | 1 | 2 | 3 | 4 | 5 | 6 |
|---|---|---|---|---|---|---|
| 0.045-0.2 mm | <0.03 | 0.03-0.045 | 0.045-0.1 | 0.1-0.2 | 0.2-0.3 | >0.3 |
| | 0.0% | ≤5.0% | 45-70% | 30-55% | ≤5.0% | 0.0% |
| 0.1-0.3 mm | <0.045 | 0.045-0.1 | 0.1-0.2 | 0.2-0.3 | 0.3-0.4 | >0.4 |
| | 0.0% | ≤8.0% | 50-65% | 25-40% | ≤7.0% | 0.0% |
| 0.5-1.0 mm | <0.4 | 0.4-0.5 | 0.5-0.8 | 0.8-1.0 | 1.0-1.2 | >1.2 |
| | 0.0% | ≤8.0% | 25-40% | 50-65% | ≤7.0% | 0.0% |

Results of analysis of technical characteristics, proportion of crystalline SiO₂, amorphous SiO₂ (through X-ray diffraction (XRD) and infrared spectroscopy (FTIR)) of the material of Hot blending Silica—PheniSilic™ obtained according to the present invention when compared with samples of crushed glass and commercial silicon dioxide are shown in the following Table 3:

TABLE 3
Chemical composition of the material of Hot blending Silica - PheniSilic ™, crushed
glass and commercial silicon dioxide

| | Chemical composition | | | | | | | | | |
|---|---|---|---|---|---|---|---|---|---|---|
| | SiO₂ | Fe₂O₃ | Al₂O₃ | CaO | MgO | SO₃ | K₂O | Na₂O | TiO₂ | MKN |
| Unit | % | % | % | % | % | % | % | % | % | % |
| PheniSilic ™ | 83.09 | 0.15 | 5.92 | 2.17 | 0.37 | 0.01 | 0.57 | 6.52 | 0.07 | 0.09 |
| 01 | (amorphous) | | | | | | | | | |
| | 1.02 | | | | | | | | | |
| | (crystalline) | | | | | | | | | |
| | total 84.11 | | | | | | | | | |
| PheniSilic ™ | 69.68 | 0.14 | 4.62 | 2.02 | 0.07 | 0.00 | 0.16 | 3.31 | 0.05 | 0.06 |
| 20 | (amorphous) | | | | | | | | | |
| | 19.89 | | | | | | | | | |
| | (crystalline) | | | | | | | | | |
| | total 89.57 | | | | | | | | | |
| PheniSilic ™ | 43.61 | 0.14 | 3.71 | 1.67 | 0.07 | 0.00 | 0.06 | 2.53 | 0.05 | 0.05 |
| 50 | (amorphous) | | | | | | | | | |
| | 48.12 | | | | | | | | | |
| | (crystalline) | | | | | | | | | |
| | total 91.73 | | | | | | | | | |
| crushed glass | 67.27 | 0.30 | 8.12 | 5.100 | 0.10 | 0.00 | 0.53 | 15.47 | 0.19 | 0.00 |
| commercial | 99.11 | 0.05 | 0.03 | 0.00 | 0.00 | 0.00 | 0.00 | 0.00 | 0.09 | 0.21 |
| silicon dioxide | | | | | | | | | | |
| (sand, quartz) | | | | | | | | | | |

*MKN: Weight loss after heated

Also, in other examples when adjusting the desired amorphous silicon dioxide ratio will give results as shown in table 4 or the like:

TABLE 4
the products of Hot blending Silica - PheniSilic ™ obtained
from the present invention

| | Component A | | Component B | | The total |
|---|---|---|---|---|---|
| | (amorphous | | (crystalline | | content of |
| | silicon | | silicon | | silicon |
| | dioxide), %, | | dioxide), % | | dioxide |
| | % in | | % in | | in A/B |
| Product type | mixture | % SiO2 | mixture | % SiO2 | miture, % |
| PheniSilic ™ 01 | 99 | 85 | 1 | 99.9 | 85.1 |
| PheniSilic ™ 02 | 98 | 85 | 2 | 99.9 | 85.3 |
| PheniSilic ™ 05 | 95 | 85 | 5 | 99.9 | 85.7 |
| PheniSilic ™ 10 | 90 | 85 | 10 | 99.9 | 86.5 |
| PheniSilic ™ 20 | 80 | 85 | 20 | 99.9 | 88.0 |
| PheniSilic ™ 30 | 70 | 85 | 30 | 99.9 | 89.5 |
| PheniSilic ™ 40 | 60 | 85 | 40 | 99.9 | 91.0 |
| PheniSilic ™ 50 | 50 | 85 | 50 | 99.9 | 92.5 |

### Color

The color of the silica sample was determined on a colorimeter Xrite C17800, Xrite, US. Color measurement method based on the principle of reflection using CIE Lab color space, L*, a*, b*, ΔE* according to ASTM E313-10:2010. The results are shown in Table 5.

Màu s [symbol] c c [symbol] a m [symbol] u silic [symbol] ioxit [symbol] c xác [symbol] nh trên thi [symbol] t b [symbol] [symbol] o màu Xrite C17800, Xrite, M\tilde{y}. Ph [symbol] ng pháp z,34 o màu theo nguyên lý ph [symbol] n x [symbol] , s [symbol] d [symbol] ng không gian màu CIE Lab, L*, a*, b*, ΔE* theo tiêu chu [symbol] n ASTM E313-10:2010. K [symbol] t qu [symbol] [symbol] c th [symbol] hi [symbol] n trong b [symbol] ng 4.
wherein:
L*: white/black (L=100: white; L=0: black)
a*: magenta/green (a*=0÷100: magenta; a*=0÷−100: green)
b*: yellow/blue (b*=0÷100: yellow; a*=0÷−100: blue).

TABLE 5
The L*, a*, b* parameters of the samples of Hot blending
Silica - PheniSilic ™ material in the invention
and commercial silicon dioxide

| Samples | L* | a* | b* |
|---|---|---|---|
| PheniSilic ™ 01 | 95.50 | −0.45 | 0.71 |
| PheniSilic ™ 02 | 95.41 | −0.41 | 0.77 |
| PheniSilic ™ 05 | 94.98 | −0.34 | 0.95 |
| PheniSilic ™ 10 | 94.52 | −0.12 | 1.15 |
| PheniSilic ™ 20 | 94.12 | −0.01 | 1.34 |
| PheniSilic ™ 30 | 93.84 | 0.06 | 2.15 |
| PheniSilic ™ 40 | 93.05 | 0.15 | 2.61 |
| Commercial silicon dioxide | 92.41 | 0.24 | 2.89 |

### Example 2: Effect of PheniSilic™ Materials Obtained in Example 1. On the Machinability and Physical and Mechanical Properties of Artificial Stone Products

Use the PheniSilic™ material of example 1 with different ranges of particle size and different blending ratios according to the calculated optimal formula to create the samples of artificial stone in the laboratory and compare with the sample of artificial stone used completely crystalline SiO₂ material with the same optimal method and formula.

The artificial stone samples using unsaturated polyester resin, are made by press vibration method in a vacuum environment and are cured by heating method at 130° C. for 40 minutes and have the dimensions of 300×300×20 mm. The total weight of raw materials to make the stone samples is 5000 g. In particular, the mixed ingredients to make artificial stone samples include 580 g of unsaturated polyester resin (11.6% of the total weight of raw materials), the resin includes additives for curing process. The PheniSilic™ material of example 1 or crushed glass, that used, includes 1165 g in form of powder with a size≤0.1 mm (23.3% of total material weight) and 3255 g in form of powder with a size of 0.1÷0.4 mm (65.1% of total material weight).

The machinability and physical and mechanical properties of the artificial stone products with the above mixing formula are shown in the following Table 6.

TABLE 6
Comparison of the machinability of the samples of the artificial stone products
using PheniGlass ™ materials, crushed glass and commercial silicon dioxide

| | Nguyên v [symbol] t li [symbol] u | | | | | |
|---|---|---|---|---|---|---|
| | | | | | Commercial | |
| | PheniSilic ™ | PheniSilic ™ | PheniSilic ™ | Crushed | silicon dioxide | Natural |
| Parameters | 01 | 20 | 50 | glass | (quartz, sand) | Marble stone |
| Flexible | Flexible | Flexible | Flexible | Less Flexible | Flexible | |
| material after | | | | | | |
| press vibration | | | | | | |
| Curing | 130 | 130 | 130 | 130 | 130 | |
| temperature | | | | | | |
| (° C.) | | | | | | |
| Curing time | 40 | 40 | 40 | 40 | 40 | |
| (phút) | | | | | | |
| The sample | Not blistered | Not blistered | Not blistered | Blistered | Not blistered | |
| after curing | and pitted | and pitted | and pitted | and pitted | and pitted | |
| Arading ability | Easy to abrade, | Easy to abrade, | Easy to abrade, | difficult to | Easy to abrade, | |
| | no scratches on | no scratches on | no scratches on | abrade, has | no scratches on | |
| | the surface | the surface | the surface | scratches on | the surface | |
| | | | | the surface | | |
| Cutting and | Easy to process | Easy to process | Easy to process | Easy to chip | Easy to process | Easy to chip |
| processing | | | | or break when | | or break when |
| ability | | | | processing | | processing |

The artificial stone products, using the materials of PheniSilic™ and regular silicon dioxide, have similar curing time, flexible material after press vibration, polishing, and no scratches on the surface (table 6). Meanwhile, the artificial stone sample using crushed glass is difficult to process, less flexible after press vibration, blistered, pitted and difficult to abrade, has scratches on the surface, and is not polishing.

TABLE 7
Effect of materials on the physical and mechanical
properties of the artificial stone product

| | Flexural strength, | Water absorption, | Impact resistance, | Scratch hardness |
|---|---|---|---|---|
| Properties | N/mm² | % | J | of surface, Mohs |
| Test method | BS EN 14617- | BS EN 14617- | BS EN 14617- | EN 101: 1991 |
| | 2: 2016 | 1: 2013 | 9: 2005 | |
| Standard value | 40.0 ÷ 120.0 | 0.01 ÷ 0.05 | ≥3.0 | 6.0 ÷ 8.0 |
| PheniSilic ™ 01 | 74.37 | 0.021 | 8.13 | 6 |
| PheniSilic ™ 20 | 61.32 | 0.019 | 8.55 | 7 |
| PheniSilic ™ 50 | 74.41 | 0.015 | 9.11 | 7 |
| Crushed glass | 36.71 | 0.053 | 2.91 | 4 |
| Comon silicon | 63.10 | 0.021 | 7.35 | 7 |
| dioxide | | | | |
| (quartz, sand) | | | | |
| Natural Marble | 14.50 | 0.106 | 3.71 | 6 |
| stone | | | | |

From Table 7, it can be seen that the artificial stone products using PheniSilic™ materials have physical and mechanical properties equivalent to artificial stone products using commercial silicon dioxide and have superior properties compared to natural granite samples. The artificial stones using the Hot blending Silica—PheniSilic™ material have good flexural strength and impact resistance, this results to easy processing and not cause chipping or breakage.

The Hot blending Silica—PheniSilic™ material has properties equivalent to quartz/silica sand and especially with the advantage of not generating silica dust in the crystalline form or controlled emission during the production and processing of an artificial stone products, thereby reducing harmful effects on human health through the respiratory tract due to the use of materials such as quartz/silica sand.

### The Advantageous Effect of the Invention

Unlike the use of commercial silica (>99% crystalline silicon dioxide) in the production of artificial stone, the process of the present invention produces the material of hot blending Silica—PheniSilic™ from materials containing silicon dioxide such as sand, cristobalite, crushed glass, waste rock powder/burrs from process of producing artificial stone, waste products and by-products from the exploitation and processing of natural quartz stone in which the materials have the amorphous silicon dioxide content is in range from 50 to 99% by weight and the crystalline silicon dioxide content is in range from 1 to 50% by weight, the total silicon dioxide content in ranges from about 70% to 95% by weight, that used for the production of artificial stone, thus the materials can be processed more easily than natural granite and ensure the possibility of silicon dust generation below the allowable level similar to natural granite. The process of the present invention combines molten amorphous silicon dioxide (molten glass) and crystalline silicon dioxide (calcined impurities-removed sand and cristobalite) to create a new material type of Hot blending Silica—PheniSilic™ which has properties similar to commercial silicon dioxide with a total silicon dioxide content of about 70% to 95% by weight.

The process of the present invention takes advantage of solid waste from quartz stone production (waste rock powder/burrs from process of producing artificial stone with particle size ranging from 0.1 to 10 mm), waste products, by-product from the exploitation and processing of natural quartz stone, and helps minimize solid emissions into the environment thanks to the appropriate mixing process and heat map of the heating of the raw material mixture to create molten glass during the heating step. Besides, the homogeneous mixing helps control the ratio of amorphous silicon dioxide and crystalline silicon dioxide to obtain the Hot blending Silica—PheniSilic™ product with the desired content and composition of amorphous silicon dioxide.

The Hot blending Silica—PheniSilic™ material of the present invention has properties similar to quartz/silica sand and especially with the advantage of not generating silica dust in the crystalline form or controlled emission during the production and processing of an artificial stone products, thereby reducing harmful effects on human health through the respiratory tract due to the use of materials such as quartz/silica sand.

The present invention has provided an artificial stone product using a reinforcement that is the Hot blending Silica—PheniSilic™ material or mixture of the Hot blending Silica—PheniGlass™ material with quartz, cristobalite, sand. The artificial stone product of the invention has a flexural strength≥40 N/mm², a water absorption≤0.05%, an impact resistance≥3J.

The invention claimed is:

1. A Process for producing a hot blended material of amorphous silicon dioxide—crystalline silicon dioxide from materials containing silicon dioxide, wherein the process comprises the following steps:
i) heating a mixture of sand, crushed glass and solid waste from quartz stone production in amount of 60 to 90% by weight together with Na₂O in amount of 1 to 10% by weight, Al₂O₃ in amount of 1 to 10% by weight, CaCO₃/MgCO₃ in amount of 5 to 10% by weight and processing aid at a temperature between 1000° C. and 1600° C. to obtain molten amorphous silicon dioxide component with amorphous silicon dioxide in range of 50 to 90% by weight;
ii) preparing crystalline silicon dioxide by mixing of calcined impurities-removed sand with cristobalite, wherein the crystalline silicon dioxide is prepared as follow:
calcining first sand at temperature in range of 1000 to 1600° C. for removing impurities to obtain the calcined impurities-removed sand; and
calcining second sand with alkali salts or alkali hydroxides at temperature in range of 1000 to 1600° C. to obtain the cristobalite;
iii) mixing the molten amorphous silicon dioxide with the crystalline silicon dioxide to yield a mixture, wherein a proportion of the molten amorphous silicon dioxide is in range from 50 to 99% by weight and a proportion of crystalline silicon dioxide is in range of 1 to 50% by weight, wherein a total silicon dioxide of an obtained product ranges from about 70% to 95% by weight;
iv) cooling the mixture of the molten amorphous silicon dioxide and the crystalline silicon dioxide quickly to form a large-particle mass; and
v) grinding the large-particle mass from the step (iv) by a mill system to obtain the hot blended material of amorphous silicon dioxide—crystalline silicon dioxide with specified sizes.

2. The Process according to claim 1, wherein at the step (i), the heating is performed at 1300° C. for 2 hours.

3. The Process according to claim 1, wherein at the step (ii), the calcining to obtain the calcined impurities-removed sand is performed at 1300° C. for 2 hours and the calcining to obtain the cristobalite is performed at 1500° C. for 2 hours.

4. A Material obtained from the process according to claim 1, wherein the material consists of following:
70%<SiO₂<95% by weight, wherein the amorphous silicon dioxide is in range from 50 to 90% by weight, and the crystalline silicon dioxide is in range from 1 to 50% by weight;
1.0%<Na₂O<10% by weight;
1.5%<CaO/MgO<10% by weight;
1.0%<Al₂O₃<10% by weight;
Fe₂O₃<0.1% by weight; and
TiO₂<0.1% by weight.

5. A Process for producing artificial stone, wherein the process comprises the following steps:
i) heating a mixture of sand, crushed glass and solid waste from quartz stone production in amount of 60 to 90% by weight together with Na₂O in amount of from 1 to 10% by weight, Al₂O₃ in amount of 1 to 10% by weight, CaCO₃/MgCO₃ in amount of 5 to 10% by weight and processing aid at a temperature between 1000° C. and 1600° C. to obtain molten amorphous silicon dioxide component with amorphous silicon dioxide in range of 50 to 90% by weight;
ii) preparing crystalline silicon dioxide by mixing of calcined impurities-removed sand with cristobalite, wherein the crystalline silicon dioxide is prepared as follows:
calcining first sand at temperature in range of 1000 to 1600° C. for removing impurities to obtain the calcined impurities-removed sand;
calcining second sand with alkali salts or alkali hydroxides at temperature in range of 1000 to 1600° C. to obtain the cristobalite;
iii) mixing the molten amorphous silicon dioxide with the crystalline silicon dioxide to yield a mixture wherein a proportion of the molten amorphous silicon dioxide is in range from 50 to 99% by weight and a proportion of crystalline silicon dioxide is in range of 1 to 50% by weight, wherein a total silicon dioxide of an obtained product ranges from about 70% to 95% by weight;
iv) cooling the mixture of the molten amorphous silicon dioxide and the crystalline silicon dioxide to form a large-particle mass;
v) grinding the large-particle mass from the step (iv) by a mill system to obtain the hot blended material of amorphous silicon dioxide—crystalline silicon dioxide with specified sizes; and
(vi) producing artificial stone products by using blended material of the amorphous silicon dioxide—crystalline silicon dioxide obtained in the step (v) and base resins by press-vibration method in a vacuum environment, in which a ratio of the base resin used is in range from 6 to 15% by weight and a ratio of the blended material of the amorphous silicon dioxide-crystalline silicon dioxide obtained in the step (v) is in range from 85 to 94% by weight.

6. The process for producing Artificial stone product according to claim 5, wherein the artificial stone products comprise the base resin with the ratio in range from 6 to 15% by weight and the hot blended material of amorphous silicon dioxide crystalline silicon dioxide with the ratio in range from 85 to 94% by weight, wherein a total ratio of silicon dioxide is range from 70% to 95% by weight and the artificial stone products have a flexural strength≥40 N/mm², a water absorption≤0.05%, and an impact resistance≥3J.
